(19) United States
(12) Patent Application Publication
(10) Pub. No.: US 2015/0218440 A1
(43) Pub. Date: Aug. 6, 2015

(54) SYSTEMS AND METHODS FOR PROVIDING POLYMERS TO A FRACTURING OPERATION

(71) Applicant: Aspen Polymer Company, Inc., Freeport, TX (US)

(72) Inventors: Kirk Johnson, Lakeway, TX (US); Wayne Tramel, Longview, TX (US)

(73) Assignee: Aspen Polymer Company, Inc., Freeport, TX (US)

(21) Appl. No.: 14/172,567

(22) Filed: Feb. 4, 2014

(51) Int. Cl. C09K 8/88; E21B 43/267; E21B 43/26

(52) U.S. Cl. CPC C09K 8/882; E21B 43/26; E21B 43/267

(57) ABSTRACT

Methods for providing polymer to a wellbore site include mixing a dry polymer with an aqueous medium at a location remote from the wellbore for a period of time sufficient for substantially complete hydration, transporting the hydrated polymer solution to the wellbore site, and injecting at least a portion of the hydrated polymer solution external to a chemical blending tub at the wellbore site to reduce shearing of the polymer. The hydrated polymer solution can be injected at the low or high pressure regions of the system manifold, before or after the high pressure pumps, before or after the blending tub, or any combination of injection points. Non-ionic polymer solutions can be used due to the fact that the solution is hydrated prior to transport, and no additional mixing or fluid at the wellbore site is necessary to hydrate the polymer.

### FIELD OF THE PRESENT DISCLOSURE

Embodiments usable within the scope of the present disclosure relate, generally, to systems and methods usable to provide polymers to a fracturing or coil tubing operation, and more specifically, to systems and methods usable to provide polymers to an operation in a state that is ready for use (e.g., hydrated).

### BACKGROUND

To stimulate and/or increase the production of hydrocarbons and/or other substances from a well, a process known as fracturing (colloquially referred to as “fracing”) is performed. In brief summary, a pressurized fluid—often water, though other fluids can also be used—is pumped into a producing region of a formation at a pressure sufficient to create fractures in the formation, thereby enabling hydrocarbons to flow from the formation with less impedance. Solid matter, such as sand, ceramic beads, and/or similar particulate-type materials, can be mixed with the fracturing fluid, this material generally remaining within the fractures after the fractures are formed. The solid material, known as proppant, serves to prevent the fractures from closing and/or significantly reducing in size following the fracturing operation, e.g., by “propping” the fractures in an open position. Following the fracturing operation, coiled tubing is lowered into the wellbore to drill and/or otherwise remove plugs applied during the fracturing operation and/or flush other materials from the wellbore.

It is normally desirable to treat water and/or other types of fracturing fluids with a polymeric friction reducer, such as polyacrylamide or other types of polymers, an exemplary list of which is described in published United States Patent Application 2013/0112419, which is incorporated by reference herein in its entirety. Use of such polymers can reduce the effects of internal friction within the fluid, thereby decreasing the hydraulic power required to rapidly pump the fluid into the formation, and in some cases, can reduce pressure losses caused by internal friction by as much as 75%. Similarly, when performing coiled tubing operations, polymeric friction reducers are used to facilitate installation and operation of coiled tubing and reduce internal friction in the fluids used for such operations.

Typically, a suitable polymer is transported to an operational site in an emulsified state, in which dry polymer is suspended in mineral oil or another similar non-aqueous liquid, along with various surfactants, with which the polymer will not significantly react or hydrate. Once the polymer emulsion reaches an operational site, it can be passed through an on-site blending tub and the high pressure pumps used to inject the fracturing fluid into the wellbore, such that system turbulence and shear forces mix the polymer with the (normally aqueous) fracturing fluid, at least partially hydrating the polymer. The hydrated polymer can thereby reduce internal friction in the fracturing fluid, facilitating injection thereof during the fracturing operation.

The hydrocarbons and/or other components used to prepare polymer emulsions are generally necessary to protect the dry polymer from exposure to water, which would otherwise cause premature hydration of portions of the polymer. These non-aqueous emulsion fluids can often present environmental and/or safety concerns. In a similar manner, polymer emulsions can often present difficulties relating to storage due to the fact that any incidental contact with fresh water, such as condensate in a storage tank, or any other exposure, can cause the polymer to hydrate prior to use. This premature hydration can result in the formation of “fisheyes” and other types of lumps/irregularities in the emulsion, which cannot be redispersed or can cause the product to be unusable. Stored polymer emulsions can also be prone to separation.

The on-site hydration of polymers, e.g., in a chemical blending tank/tub or similar vessel, can be extremely time consuming, requiring several hours or longer, while very little time and on-site space is allotted to such a process. Typically, a polymer emulsion is injected directly into the chemical blending tub at an operational site, where hydration and mixing begins, the polymer is passed through the manifold, pressurized by the high pressure pumps, and injected into the wellbore. This process agitates and mixes the polymer, while exposing it to aqueous fluid, thereby partially, but not fully, hydrating the polymer. Therefore, polymer emulsions are often not fully hydrated at the time of injection into in the wellbore nor at the time the fracturing fluid reaches the target zone; typically, only 40-60 percent of the polymer is hydrated and functioning to reduce internal friction in the fluid during the fracturing process. The remaining polymer in the emulsion can continue to hydrate within the formation, causing portions of the polymer to block fractures and inhibit the flow of hydrocarbons from the formation into the wellbore. Additionally, some of the unhydrated polymer may return to the surface during flowback operations, which can damage and/or hinder surface and/or processing equipment.

Polymers usable as friction reducers can be cationically charged, anionically charged, or non-ionic. Anionically charged polymer emulsions are typically used due to the anionic charge partially protecting the polymer from exposure to various charged substances in the wellbore and/or the operational site, though in various conditions, a cationically charged polymer emulsion may be more suitable for use with certain fracturing fluids. Ideally, non-ionic polymer emulsions would be preferable due to the fact that non-ionic emulsions are generally non-reactive with high brine fracturing fluids or other wellbore fluids, such as water used during coiled tubing operations. Due to the widespread use of recycled water, which contains large quantities of ionic components, many anionic and cationic polymers can be hindered by exposure to operational fluids. However, non-ionic polymer solutions also require a significantly larger quantity of time to properly hydrate, leading to the widespread use of less advantageous anionic and/or cationic solutions. Injection of an emulsion of non-ionic polymer into a chemical blending tub, in the manner common to that of anionic or cationic polymer emulsions, would result in hydration of a very small percentage of the non-ionic polymer solution (e.g., from 1 to 10 percent), requiring non-economic and potentially damaging quantities of polymer to effectively reduce friction during operations. As a result, the use of non-ionic polymer for conventional operations is generally not possible, even though non-ionic polymer is significantly less impacted by brine and other components found in fracturing fluid and fluid used during coiled tubing operations.

A need exists for systems and methods for providing polymer to a fracturing operation that can enable the injection of substantially fully hydrated polymer into a wellbore, at multiple injection points (including injection points outside of a chemical blending tub), while overcoming the difficulties inherent in the storage and protection of polymer prior to hydration and the time necessary to hydrate a polymer.

### BRIEF SUMMARY OF THE INVENTION

Embodiments usable within the scope of the present disclosure include systems and methods for providing polymer to a wellbore site (e.g., for use during a fracturing operation or coiled tubing completions). A wellbore site can include, for example, a wellbore, a manifold system, and one or more high pressure pumps (e.g., fracturing pumps), among other components, that conceptually divide the site into a low pressure region and a high pressure region. In various embodiments, a wellbore site can include a vessel for containing a polymer solution, such as a fracturing water storage tank, chemical transport tanker, or similar container and/or tank.

At a location remote from the wellbore, a dry polymer (e.g., polyacrylamide or another usable polymer) can be blended, pulverized, sheared, and/or otherwise manipulated, and hydrated (e.g., via blending, mixing, and/or otherwise combining the polymer with water or another aqueous medium). In an embodiment, a non-ionic polymer can be used to due to its compatibility with the fracturing fluid; however anionic or cationic polymers could also be used without departing from the scope of the present disclosure. The polymer and aqueous medium can be mixed utilizing a high shear blending system or other type of mixing and/or blending system and stored in a mix tank or similar vessel for a period of time sufficient for the polymer to become substantially fully hydrated. While the concentration of polymer used can vary depending on the type of polymer and/or conditions at the wellbore site, as well as intended uses of the hydrated polymer solution, in an embodiment, polymer can be mixed with water or another aqueous medium at a concentration of 1.5% to 6% by weight polymer. Other additives (e.g. biocides, etc.) can also be added without departing from the scope of the present disclosure. In an embodiment, a viscosity modifier (e.g., a 0.05% to 5% sodium chloride solution or similar ionic solution) can be combined with the polymer solution to reduce the viscosity common to fully hydrated, high molecular weight polymer solutions, to allow for more efficient pouring, pumping, and/or transferring thereof.

The hydrated polymer solution can then be transported to the wellbore site, such as through use of a container associated with a vehicle (e.g., transport tankers or similar movable containers). Pumps (e.g., piston diaphragm pumps, progressive cavity pumps, or other sources of motive force) can be used to transfer the hydrated polymer solution from the mix tank or other vessel where the solution was prepared to the container associated with the vehicle, and from the container associated with the vehicle to a suitable location at the wellbore site (e.g., an on-site storage tank), which as an option, may allow for any necessary hydration of the polymer prior to use. In an embodiment, the vehicle-associated container can be pressurized (e.g., to 2-4 psi) to facilitate offloading of the hydrated polymer solution. In an embodiment, if desired, all or a portion of the hydrated polymer solution could be injected directly from the container associated with the vehicle into the wellbore in lieu of transferring the solution into a storage vessel.

In an embodiment, after transporting the hydrated polymer solution to the wellbore site, a first portion of the hydrated polymer solution (e.g., 10 to 30 percent of the total volume thereof) can be injected into the chemical blend tub prior to high pressure pump(s) and/or other conduits and/or equipment associated therewith, such as the manifold, such that the first portion of the hydrated polymer solution passes through the high pressure pump(s), thereby preparing the pump(s) to receive and inject fracturing fluid by reducing the internal friction therein. Specifically, in an embodiment, the hydrated polymer solution can be injected at or before the low pressure side of the manifold system.

A second portion of the solution (e.g., 70 to 90 percent of the total volume thereof) can be injected between the blending tub and the high pressure pumps or between the high pressure pumps and the wellbore, such that this portion of the hydrated polymer solution enters the wellbore directly, limiting a portion of the destructive shear on the hydrated polymer. Bypassing the high pressure pump(s) can prevent excessive shearing of the polymer in the solution, while reducing wear on the pump(s) that could be caused by passage of the polymer solution therethrough.

While conventional polymer emulsions must be injected into the chemical blending tub, then passed through the manifold, hydration unit, and high pressure pumps, such that the system turbulence mixes and hydrates the polymer, embodiments of the present systems and methods enable injection of a substantially fully hydrated polymer solution at one or multiple points in a system, outside of the chemical blending tub. For example, a hydrated polymer solution could be added to a fracturing tub, a blender, a blender tub, a hydration unit, the lower pressure side of the fracturing manifold, the higher pressure side of the fracturing manifold, before the blender, and/or directly behind the blender and before the fracturing manifold. The polymer solution can be injected from a single source or multiple sources, sequentially or simultaneously at multiple points of injection, and the amount of polymer solution injected at any single injection point could range from 1 percent to 100 percent of the total volume of solution pumped.

In an embodiment, injection of the hydrated polymer solution at any point associated with the wellbore can include use of a piston diaphragm pump, a progressive cavity pump, or other similar sources of motive force. In an embodiment, the injection rate of the hydrated polymer solution can range from thirty gallons per minute to fifty gallons per minute, or greater.

While the amount and rate at which the hydrated polymer solution is injected into the wellbore can vary depending on various characteristics of the wellbore and/or of the operation being performed, in an embodiment, the hydrated polymer solution can be injected with a dosage rate ranging from four gallons per thousand gallons of fracturing fluid to twelve gallons per thousand gallons of fracturing fluid, or greater.

Embodiments usable within the scope of the present disclosure thereby enable substantially fully hydrated polymer solution to be injected into a wellbore, which can be injected at one or multiple points in a system, including locations other than a chemical blending tub, such as the low pressure side of the manifold system, thereby preventing or reducing excessive shearing of the polymer, while advantageously enabling non-ionic polymers to be used despite the substantial time required for hydration thereof.

### BRIEF DESCRIPTION OF THE DRAWINGS

FIG. 1 depicts a diagram of an embodiment of a system usable within the scope of the present disclosure.

FIG. 2 depicts a diagram of an embodiment of a polymer hydration system usable within the scope of the present disclosure.

FIG. 3 depicts a diagram of an embodiment of a system usable within the scope of the present disclosure.

Like reference numbers in the various drawings indicate like elements.

### DETAILED DESCRIPTION OF ILLUSTRATIVE EMBODIMENTS

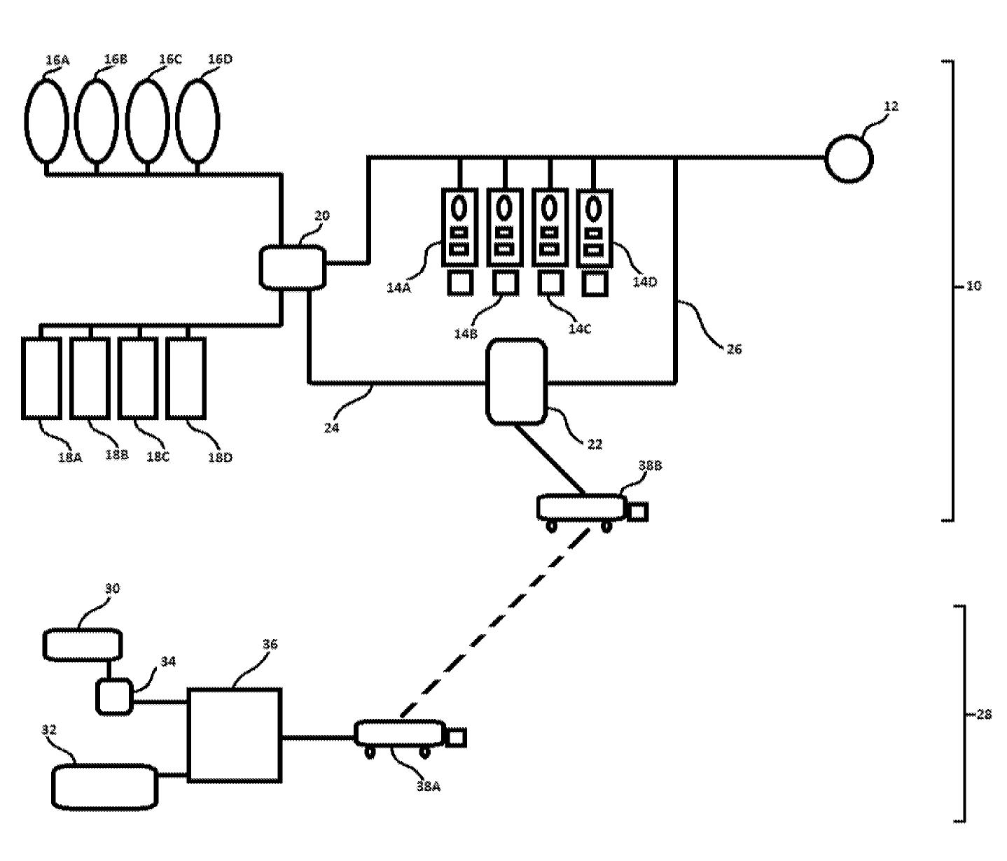

FIG. 1 depicts a diagram of a system usable within the scope of the present disclosure. Specifically, FIG. 1 depicts, generally, a wellbore site (10) where various operations, such as fracturing operations, can be performed, and a remote location (28), which can include any manner of facility or location not located immediately within the wellbore site (10). It should be understood that the term “remote location” is not limited to locations separated by any specific distance from one or more wellbore sites, and that the separation between the wellbore site (10) and remote location (28) illustrated in FIG. 1 is solely conceptual. For example, a “remote location” could be within the same site as a wellbore, but separated from the fracturing operation and/or other operations being performed. Additionally, while FIG. 1 depicts a single wellbore site (10) associated with a single remote location (28) usable to produce and supply polymer solution thereto, it should be understood that in various embodiments, a single remote location could supply hydrated polymer solution to multiple wellbore sites and/or multiple remote locations could produce and transport polymer solution to a single wellbore site.

The wellbore site (10) is shown including a well (12) into which fracturing fluid and proppant can be supplied using a plurality of high pressure pumps (14A-14D). Specifically, fracturing fluid (e.g., water or a similar fluid), stored in a plurality of fluid storage vessels (16A-16D), and proppant from a plurality of proppant storage containers (18A-18D), can be flowed to a blending tub (20), hopper, or similar mixing and/or blending vessel, then subsequently pressurized using the high pressure pumps (14A-14D) and flowed into the wellbore (12).

As described previously, to reduce internal friction within the fracturing fluid, a polymer solution, such as a solution of a high molecular weight polyacrylamide (e.g., a molecular weight of about 15 to 22 million), can be introduced into the depicted system. While polyacrylamide, having a molecular weight ranging from 15 to 22 million is cited as one possible example of a usable polymer, it should be understood that any polymer or co-polymer having any desired molecular weight could be used without departing from the scope of the present disclosure, depending on the wellbore conditions, the nature of the operation to be performed, the fluids and/or equipment used, etc.

The remote location (28) can include, for example, a mobile or fixed facility having a controlled climate (e.g., controllable humidity), and can include equipment, containers, pumps, conduits, and associated components usable to prepare a hydrated polymer solution. Polymer from a polymer source (30) can be passed through a blending system (34) or similar equipment, which is usable to pulverize or wet grind dry polymer while mixing the polymer with water or a similar aqueous medium from a liquid source (32) for hydration thereof, e.g., in a mixing tank (36). For example, the blending system (34) could include a closed cage device having a combination of fixed and moving blades spaced apart (e.g., at a spacing of 50 to 500 microns, with a clearance of 50 to 500 microns), mounted on a rotor, can be used to wet grind the dry polymer into particles of a desired size (e.g., 200 microns or smaller) while uniformally blending the polymer and water. Such a device is manufactured by Urschel under the trade name Comitrol 3600, and other such devices are described in U.S. Pat. Nos. 4,845,192; 4,877,588; and 4,529,794, each of which are incorporated by reference herein in their entirety. The polymer and aqueous medium can be stored in the mix tank (36) until substantially fully hydrated before being transferred.

While the concentration of the polymer solution can vary depending on the type of polymer used, the nature of the operation(s) to be performed using the polymer solution, one or more wellbore conditions, and/or other factors, in an embodiment, the polymer can be blended at a concentration ranging from 1.5 percent to 6 percent polymer, by weight. Prior to blending with the polymer, the water can be treated with one or more additives, such as a biocide (e.g., an industry standard quick-kill biocide, such as 12.5% glutaraldehyde, chloride dioxide, or other types of antibacterial treatments at a dosage applicable to the type of biocide used).

While embodiments usable within the scope of the present disclosure can include use of anionic and/or cationic polymers, it should be noted that non-ionic polymers can be used despite the increased length of time required for full hydration thereof, due to the completion of the hydration process at the remote location (28) prior to transport of the hydrated polymer solution to the wellbore site (10).

Following substantially complete hydration of the polymer solution, the hydrated polymer solution can be transferred, e.g., using one or more piston diaphragm pumps, progressive cavity pumps, or similar types of equipment, into a means of transport for the solution, such as a container associated with a vehicle. For example, FIG. 1 depicts a transport tanker (38A) (e.g., a stainless steel tank or other type of tank, vessel, container, etc., associated with a truck, trailer, and/or other type of prime mover) positioned in communication with the mix tank (36) for receiving hydrated polymer solution therefrom. It should be understood that the depicted tanker (38A) can be representative of a plurality of vehicles and/or similar means of transport, depending on the type and quantity of polymer solution to be transported and one or more characteristics of the means of transport.

Following preparation of the hydrated polymer solution and placement thereof in the transport tanker (38A), the solution can be transported from the remote location (28) to the wellbore site (10), where the transport tanker (38B) can offload the hydrated polymer solution. For example, FIG. 1 depicts the tanker (38) in association with a polymer storage vessel (22) at the wellbore site (10). Polymer solution can be transferred from the tanker (38B) to the vessel (22) using pumps (e.g., piston diaphragm and/or progressive cavity pumps) and/or other similar sources of motive force. In an embodiment, the tanker (38B) can be pressurized (e.g., from 2 to 4 psi) to facilitate offloading of the solution.

It should be understood that while FIG. 1 depicts a single tanker (38B) and polymer storage vessel (22), any number of tankers and/or similar transportable containers and any number of destination/storage vessels can be used without departing from the scope of the present disclosure. Additionally, while FIG. 1 depicts an embodiment in which hydrated polymer solution from the tanker (38B) can be stored in the vessel (22) for later use, in various embodiments, polymer solution could be transferred directly from the tanker (38B) into one or more regions of the depicted system for communication into the wellbore (12). Because the polymer solution can be substantially fully hydrated at the time of transport to the wellbore site (10), additional mixing of water with the polymer (e.g., for dilution, facilitating pumping, and/or further hydration) is unnecessary. However, in an embodiment, polymer within the storage vessel (22) can continue to hydrate; for example, additional on-site blending, mixing, and/or the addition of water to the vessel (22) could be undertaken to complete hydration of the polymer prior to injection thereof.

The hydrated polymer solution can be stored at the wellbore site (10) until needed for friction reduction, e.g., during a fracturing operation or coiled tubing operation. The solution can be injected into the system and toward the wellbore (12) at any desired flow and/or dosage rate, depending on the type of polymer used and/or the characteristics of the system and/or the wellbore (12). In an embodiment, the polymer solution can be injected at a dosage rate ranging from four gallons per thousand gallons of fracturing fluid to twelve gallons per thousand gallons, or more, of fracturing fluid, e.g., using pumps (such as piston diaphragm and/or progressive cavity pumps to flow 30 to 50 gallons of solution per minute via hoses and/or similar conduits and/or connectors), depending on the fracturing or coil tubing pump rates. It should be understood, however, that any dosage and/or flow rates can be used, in conjunction with any type of equipment capable of flowing the polymer solution, without departing from the scope of the present disclosure.

As depicted in FIG. 1, hydrated polymer solution is injected at two locations within the system; however, as described above, in various embodiments, the hydrated polymer solution could be injected at one or multiple locations within the system, including locations outside of the chemical blending tub (20). A first portion of the solution is shown able to be injected at the chemical blending tub (20), e.g., via a first conduit (24). In an embodiment, this first portion of the solution can include from 10 to 30 percent of the total volume of polymer solution that is pumped. The first portion of the polymer solution can thereby flow from the chemical blending tub (20) into association with the high pressure pumps (14A-14D) prior to being injected into the wellbore (12), thereby preparing the pumps to receive fracturing fluid (e.g., by reducing internal friction therein). A second portion of the solution can be injected between the high pressure pumps (14A-14D) and the wellbore (12), though it should be understood that in other embodiments, the solution could be injected into the low pressure side of the system manifold prior to the high pressure pumps and/or into the high pressure side of the manifold to reduce shearing of the polymer. In an embodiment, the second portion can include from 70 to 90 percent of the total volume of the polymer solution being pumped. As depicted in FIG. 1, the second portion of the polymer solution can bypass the high pressure pumps (14A-14D), preventing both shearing of the polymer and wear on the pumps that may be caused by passage therethrough.

It should be understood that while FIG. 1 illustrates two points at which hydrated polymer solution can be added to the depicted system, in various embodiments, other points of addition could also be used. For example, hydrated polymer solution could be added to a fracturing tub, a blender, a blender tub, a hydration unit, the lower pressure side of the fracturing manifold, the higher pressure side of the fracturing manifold, before the blender, and/or directly behind the blender and before the fracturing manifold. The polymer solution could also be added before the blending tub (20) (e.g., into or in association with the fracturing fluid tanks (16A-16D) and/or proppant storage vessels (18A-18D)). The polymer solution can be injected from a single source (e.g., the storage vessel (22)) or multiple sources, sequentially or simultaneously at multiple points of injection, and the amount of polymer solution injected at any single injection point could range from 1 percent to 100 percent of the total volume of solution pumped.

While embodiments described herein discuss use of piston diaphragm and/or progressive cavity pumps to facilitate movement of polymer solution, in various embodiments, hydrated polymer solution can be pumped and/or injected into the system via blender pumps, hydration unit pumps, auxiliary pumps located, for example, at temporary storage tanks, on-site storage trailers, movable storage tanks, tanks usable for storing fracturing fluid and/or proppant, or any other storage vessel located at the wellbore site (10).

The transfer of hydrated polymer solution into one or more points at the wellbore site (10) can be facilitated using check valves or similar equipment. For example, one or more check valves (e.g., clapper and/or dart-actuated valves, or other types of flowback preventers and/or valves) can be positioned at the high pressure and/or low pressure sides of the fracturing manifold, before the blender, between the blender and the fracturing manifold, or any other location within the system associated with the addition of hydrated polymer solution. An exemplary check valve can be rated in excess of 15,000 psi, such as a Wier SPM #1502 check valve.

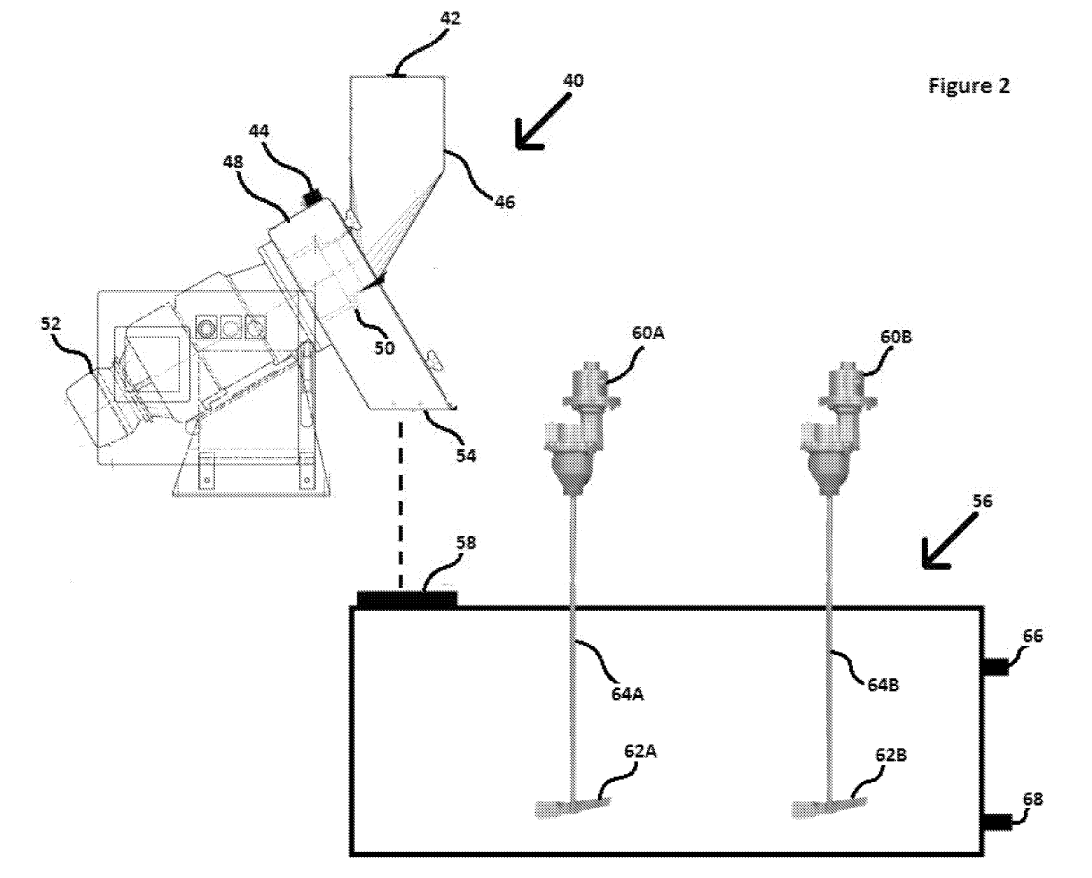

FIG. 2 depicts a diagram of a polymer hydration system usable to produce a substantially fully hydrated polymer solution, e.g., for transport to and/or use at a wellbore site. The depicted system includes a cutting and blending device (40) positioned in association with a mixing tank (56). A polymer inlet (42) is usable to receive a dry polymer (e.g., a high molecular weight (15-22 million) or similar polyacrylamide or other polymer, which in some embodiments can include a non-ionic polymer), which can pass through a hopper (46) or similar conduit into an angled cutting enclosure (48). Water can be provided into the enclosure (48) via a water inlet (44), for blending with the polymer. A cutting wheel (50) within the enclosure (48), driven by a motor (52) is usable to cut, shear, and partially mix the polymer with water as the water and polymer pass through the enclosure (48), downward along the angle thereof, to an outlet (54) for accommodating exodus of the polymer solution from the cutting and blending device (40).

Solution exiting the cutting and blending device (40) can pass through an inlet (58) of the mixing tank (56), into which additional water can be added, as needed, via a water inlet (66). Two mixers (60A, 60B) are shown, each having a blade, impeller, rotor, and/or similar structure (62A, 62B) within the interior of the tank (56), rotatable via a drive shaft (64A, 64B), for stirring, mixing, blending, agitating, and/or otherwise moving the polymer and/or water therein. Polymer and an aqueous medium can remain in the mixing tank (56) until substantially full hydration thereof. Substantially fully hydrated polymer solution can be removed from the tank (56) via a polymer solution outlet (68), e.g., via one or more pumps, and provided into a tanker or similar transportable container, or into an intermediate storage vessel for subsequent transfer to a transportable medium.

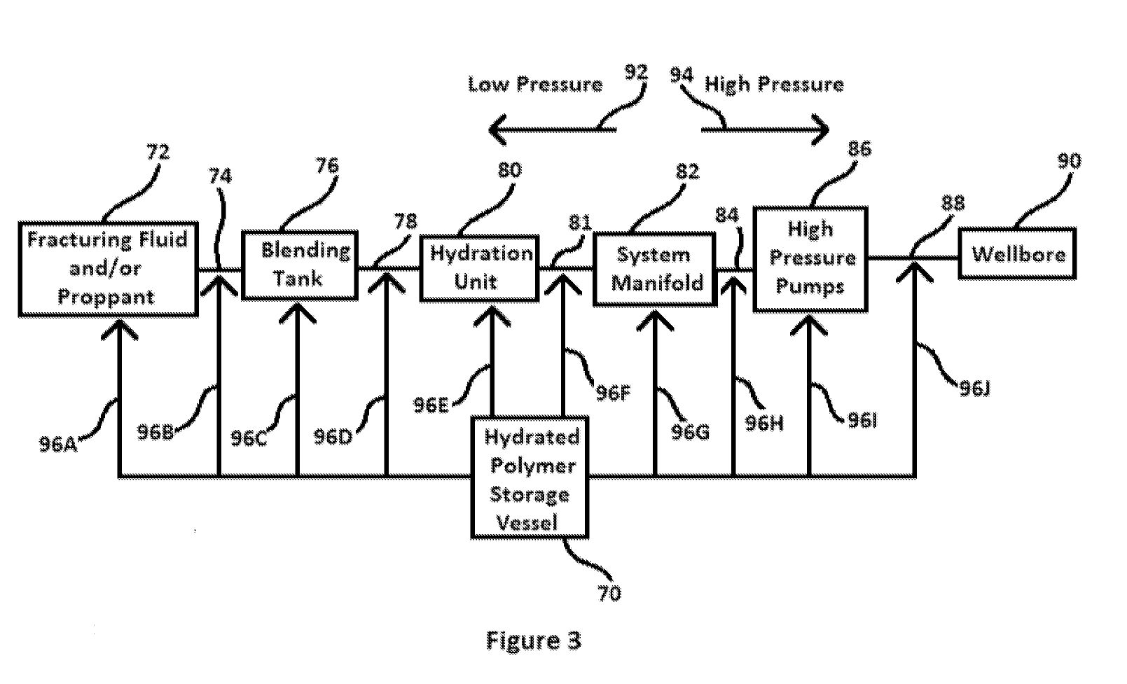

FIG. 3 depicts a diagrammatic embodiment of a system usable within the scope of the present disclosure, illustrating the ability of embodiments described herein to inject a substantially fully hydrated polymer solution at one or multiple points within a system for a fracturing and/or coiled tubing operation, including locations outside of a chemical blending tub.

The depicted system includes a storage vessel (70) for containing a substantially fully hydrated polymer solution that is positioned in association with a plurality of system components adapted for performing fracturing and/or coiled tubing operations. One or more sources of fracturing fluid and/or proppant (72) are shown associated (e.g., via one or more pumps, conduits (74), etc.) with a blending tank (76), which is in turn associated (via pumps and/or conduits (78) with a hydration unit (80), which is shown associated (via pumps and/or conduits (81)) with a system manifold (82). The system manifold (82) is shown associated with one or more high pressure pumps (86) via pumps and/or conduits (84). The high pressure pumps (86) are shown associated with a wellbore (90), e.g., via one or more conduits and/or associated equipment (88).

Conceptually, the system manifold (82) divides the depicted system into a low pressure side (92), which includes all portions of the system and all components/conduits prior to the high pressure pumps (86) (e.g., all portions between the sources of fracturing fluid and/or proppant (72) and the manifold (82)), and a high pressure side (94), which includes all portions of the system after the high pressure pumps (86) (e.g., all portions between the system manifold (82) and the wellbore (90)).

Conventional polymer injection systems exclusively provide a polymer emulsion into a chemical blending tank/tub (such as the blending tank (76)), where the blending tank begins to mix the polymer with aqueous fracturing fluid, and subsequent turbulence caused by passage of the polymer and aqueous medium through other portions of the system, including the high pressure pumps, further mixes and causes hydration of the polymer prior to and during injection into the wellbore. Each system component through which the polymer passes can potentially shear and/or otherwise reduce the effectiveness of the polymer, while the polymer can in turn cause wear on one or more system components.

As shown in FIG. 3, use of a substantially fully hydrated polymer solution can enable injection of the hydrated polymer solution at a plurality of possible injection points (96A-96J). For example, a first injection point (96A) can include the sources of fracturing fluid and/or proppant (72). A second injection point (96B) could include a region of the system prior to the blending tank (76). A third injection point (96C) could include the blending tank (76) itself. In various embodiments, all or a portion of the hydrated polymer solution could be injected after the blending tank (76), such as at a fourth injection point (96D) between the blending tank (76) and hydration unit (80), a fifth injection point (96E) at the hydration unit (80), a sixth injection point (96F) at the low pressure side of the system manifold (82), or a seventh injection point (96G) at the manifold (82) itself. In various embodiments, the hydrated polymer solution could be pressurized and injected at the high pressure side (94) of the system. For example, an eighth injection point (96H) is shown at the high pressure side of the manifold (82). A ninth injection point (961) is shown at the high pressure pumps (86). A tenth injection point (96J) is shown after the high pressure pumps (96). Injection of the hydrated polymer solution within the high pressure side (94) of the system can enable the polymer solution to bypass the high pressure pumps (86); however, the injection of the hydrated polymer solution at any point after the blending tank (76) can result in a smaller amount of shearing and/or damage to the polymer than conventional use of polymer emulsions due to the passage of the hydrated polymer solution through fewer system components.

It should be understood that while FIG. 3 depicts ten exemplary injection points (96A-96J), other injection points could be used without departing from the scope of the present disclosure. In various embodiments, substantially all of the volume of hydrated polymer solution used could be injected at a single point, or the volume of polymer solution used could be injected at any number of injection points, with any portion thereof being injected at any given point.

It will be understood that various modifications may be made to the disclosed subject matters described herein without departing from the spirit and scope of the disclosed subject matter. The present technical disclosure includes the above embodiments which are provided for descriptive purposes. However, various aspects and components of the disclosed subject matter provided herein may be combined and altered in numerous ways not explicitly described herein without departing from the scope of the disclosed subject matter, which the following claims particularly call out as novel and non-obviousness elements.

What is claimed is:

1. A method for providing polymer to a wellbore site comprising a wellbore and a blending tub, and a manifold in communication with at least one high pressure pump defining a high pressure region and a low pressure region of the wellbore site, the method comprising the steps of:
mixing a dry polymer with an aqueous medium at a location remote from the wellbore for a period of time sufficient for substantially complete hydration of the dry polymer to form a hydrated polymer solution;
transporting the hydrated polymer solution to the wellbore site; and
injecting a first portion of the hydrated polymer solution external to the blending tub.

2. The method of claim 1, wherein the step of injecting the first portion of the hydrated polymer solution external to the blending tub comprises injecting the first portion into or proximate to a low pressure region of the manifold such that the first portion of the hydrated polymer solution enters the wellbore without passing through the blending tub.

3. The method of claim 1, wherein the step of injecting the first portion of the hydrated polymer solution external to the blending tub comprises injecting the first portion into or proximate to a high pressure region of the manifold such that the first portion of the hydrated polymer solution enters the wellbore without passing through said at least one high pressure pump.

4. The method of claim 1, further comprising the step of injecting a second portion of the hydrated polymer solution into the blending tub.

5. The method of claim 4, wherein the second portion of the hydrated polymer solution comprises from ten percent to thirty percent of a total volume of the hydrated polymer solution.

6. The method of claim 1, wherein a dosage rate of the hydrated polymer solution comprises from four gallons per thousand gallons of fracturing fluid to twelve gallons per thousand gallons of fracturing fluid.

7. The method of claim 1, wherein an injection rate of the hydrated polymer solution comprises from thirty gallons per minute to fifty gallons per minute.

8. The method of claim 1, wherein the step of transporting the hydrated polymer solution to the wellbore site comprises placing the hydrated polymer solution into a container associated with a vehicle and using the vehicle to transport the container to the wellbore site.

9. The method of claim 8, further comprising the step of pressurizing the container to facilitate transfer of the hydrated polymer solution from the container to the wellbore site.

10. The method of claim 1, wherein the step of mixing the dry polymer with the aqueous medium comprises mixing a non-ionic polymer with the aqueous medium for providing the hydrated polymer solution with increased compatibility with fluid used at the wellbore site.

11. The method of claim 1, wherein the step of mixing the dry polymer with the aqueous medium comprises combining polymer with the aqueous medium at concentration of 1.5 percent to 6 percent polymer to aqueous medium.

12. A method for providing polymer to a wellbore site comprising a wellbore, a blending tub, and a manifold in communication with at least one high pressure pump defining a high pressure region and a low pressure region of the wellbore site, the method comprising the steps of:
mixing a non-ionic dry polymer with an aqueous medium at a location remote from the wellbore for a period of time sufficient for substantially complete hydration of the non-ionic dry polymer to form a non-ionic hydrated polymer solution;
transporting the non-ionic hydrated polymer solution to the wellbore site; and
injecting a first portion of the non-ionic hydrated polymer solution into the wellbore.

13. The method of claim 12, wherein the step of injecting the first portion comprises injecting the first portion at a first location external to the blending tub.

14. The method of claim 13, wherein the step of injecting the first portion at the first location external to the blending tub comprises injecting the first portion into or proximate to a low pressure region of the manifold such that the first portion of the non-ionic hydrated polymer solution enters the wellbore without passing through the blending tub.

15. The method of claim 13, wherein the step of injecting the first portion at the first location external to the blending tub comprises injecting the first portion into or proximate to a high pressure region of the manifold such that the first portion of the non-ionic hydrated polymer solution enters the wellbore without passing through said at least one high pressure pump.

16. The method of claim 13, further comprising injecting a second portion of the non-ionic hydrated polymer solution at a second location different from the first location.

17. The method of claim 16, wherein the step of injecting the second portion at the second location comprises injecting the second portion into the blending tub.

18. The method of claim 16, wherein the step of injecting the second portion at the second location comprises injecting the second portion external to the blending tub.

19. A method for providing polymer to a wellbore site comprising a wellbore, a vessel for containing polymer solution, a blending tub, and a manifold in communication with at least one high pressure pump defining a high pressure region and a low pressure region of the wellbore site, the method comprising the steps of:
mixing a dry polymer with an aqueous medium at a location remote from the wellbore for a period of time sufficient for substantially complete hydration of the dry polymer to form a hydrated polymer solution;
placing the hydrated polymer solution into a container associated with a vehicle;
transporting the vehicle and the container to the wellbore site;
transferring the hydrated polymer solution from the container associated with the vehicle to the vessel at the wellbore site;
injecting a first portion of the hydrated polymer solution from the vessel into the blending tub through such that the first portion of the hydrated polymer solution passes through said at least one high pressure pump, thereby preparing said at least one high pressure pump for injecting fracturing fluid, wherein the first portion comprises from ten percent to thirty percent of a total volume of the hydrated polymer solution;
injecting a second portion of the hydrated polymer solution from the vessel to a location external to the blending tub such that the second portion of the hydrated polymer solution enters the wellbore without passing through said blending tub, and wherein the second portion comprises from seventy percent to ninety percent of the total volume of the hydrated polymer solution; and
providing fracturing fluid and the hydrated polymer solution into the wellbore using said at least one high pressure pump.

20. The method of claim 15, wherein the step of mixing the dry polymer with the aqueous medium comprises mixing a non-ionic polymer with the aqueous medium.
